(19) United States
(12) Patent Application Publication
(10) Pub. No.: US 2006/0232912 A1
(43) Pub. Date: Oct. 19, 2006

(54) ELECTRONIC DEVICE CAPABLE OF CLEANING A DISPLAY PANEL

(76) Inventors: Meng-Hsien Lin, Tai-Chung City (TW); Kuo-Hung Liao, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/308,155

(22) Filed: Mar. 9, 2006

(30) Foreign Application Priority Data
Mar. 11, 2005 (TW) 094107513

(51) Int. Cl. H02B 1/00

(52) U.S. Cl. 361/600

(57) ABSTRACT

An electronic device includes a housing, a track formed on the housing, and a sliding bar slidable along the track. The sliding bar has a cleaning element. When the sliding bar slides along the track, the cleaning element cleans oil, dust, and such from the display panel of the electronic device.

### BACKGROUND OF THE INVENTION

1. Field of the Invention

The present invention relates to an electronic device, and more particularly, to an electronic device capable of cleaning a display panel.

2. Description of the Prior Art

Electronic products, such as mobile phones, personal data assistant (PDAs), and hand-held computers, have become indispensable to modern society. People can exchange information or communicate with others via portable electronic products anytime and anywhere. However, while using such electronic products, it is unavoidable to dirty or smear display panels of these products because of contact with human skin.

For instance, while making a call with a mobile phone, the display panel contacting the user's face might become contaminated by cosmetics or oil from the skin, thereby making the surface of display panel look dirty. If the user were to wipe the display panel with their fingers, fingerprints would be left on the display panel. Therefore, a wiping textile or other cotton fabric to remove oil or dust from the display panel is usually employed. Using the wiping textile not only cleans the display panel, but also leaves no scratches or marks on the surface of the display panel. Unfortunately, the user might not have or may lose the appropriate fabric or wiping textile to clean the display panel, making it an inconvenience.

### SUMMARY OF THE INVENTION

It is therefore a primary objective of the claimed invention to provide an electronic device capable of cleaning a display panel to solve the above-mentioned problem.

The claimed invention provides an electronic device comprising a housing, a display panel, a track formed on the housing, and a sliding bar slidable along the track. The display panel is disposed on the housing. The sliding bar has a cleaning element for cleaning the display panel when the sliding bar moves back and forth.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of main elements of the present invention electronic device.

FIG. 2 shows assembly of elements of FIG. 1.

FIG. 3 is a top view of the electronic device of FIG. 1.

FIG. 4 is a side view of a track of FIG. 1.

FIG. 5 is a diagram of main elements of the present invention foldable phone.

FIG. 6 shows the folding operation of the foldable phone.

FIG. 7 shows the unfolding operation of the foldable phone.

### DETAILED DESCRIPTION

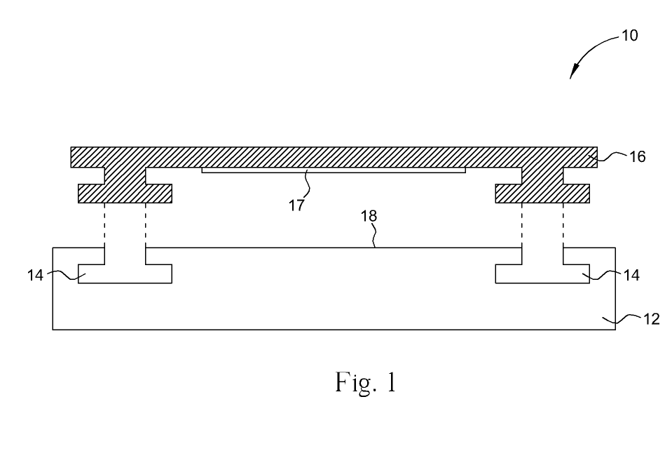

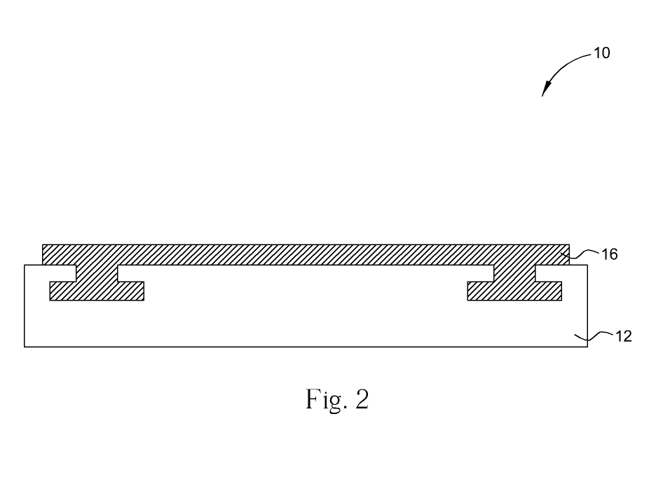

Please refer to FIG. 1, which is a diagram of elements of an electronic device 10 of the present invention. Please also refer to FIG. 2, which is a diagram of an assembly of all elements of FIG. 1. The electronic device 10 comprises a housing 12, a track 14, a sliding bar 16, and a display panel 18. The track 14 is formed on the housing 12. The sliding bar 16 is slidable along the track 14. A cleaning element 17 is disposed on the sliding bar 16 in the way that the cleaning element 17 directly contacts the display panel 18 to remove oil, dirt, cosmetics, or dust from the display panel 18 when the sliding bar 16 moves back and forth. The cleaning element 17 can be a wiping textile or other material capable of cleaning the display panel 18.

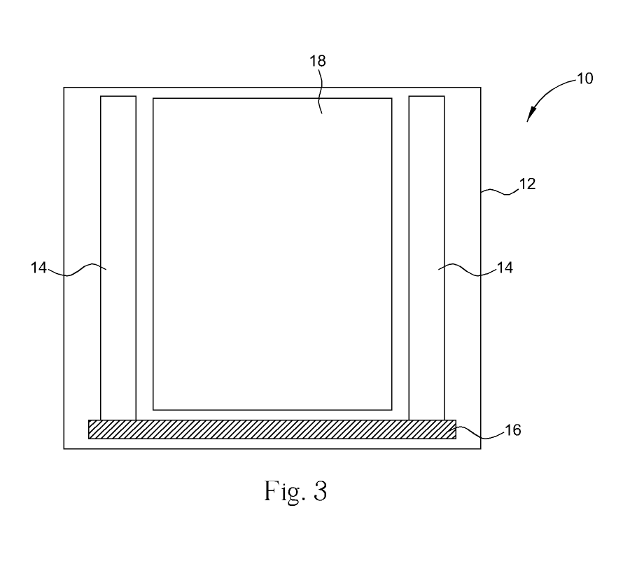

Please refer to FIG. 3, which is a top view of the electronic device 10 of the present invention. The tracks 14 are formed on both sides of the display panel 18. Preferably, the length of the sliding bar 16 is slightly longer than the width of the display panel 18, such that the cleaning element 17 can clean the entire display panel 18 while the sliding bar 16 slides along the tracks 14.

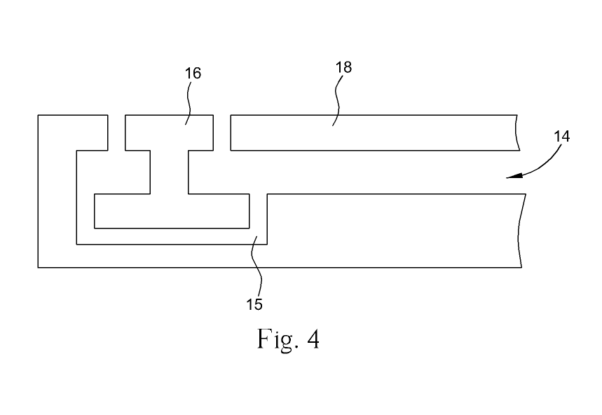

Please refer to FIG. 4, which is a side view of the track 14 of the present invention. After the work of cleaning the display panel 18, the sliding bar 16 is accommodated inside a recess 15 formed beneath an end of the track 14. The upper side of the sliding bar 16 approximately aligns with the surface of the display panel 18 when the sliding bar 16 is accommodated in the recess 15, such that the face of the electronic device 10 looks smooth. In the case that the electronic device 10 is a mobile phone, the sliding bar 16 is inside the recess 15 while the user is talking to someone via the mobile phone. The upper side of the sliding bar 16 and the display panel 18 are in the same plane, which can make the user feel comfortable when the user's face contacts the surface of the electronic device 10. The user can move the sliding bar 16 from the recess 15 to the track 14 manually. In another embodiment, a step motor can be used for driving the sliding bar 16 to move from the recess 15 to the track 14. Similarly, the sliding bar 16 can be manually slid along the track 14 or can be driven by the step motor.

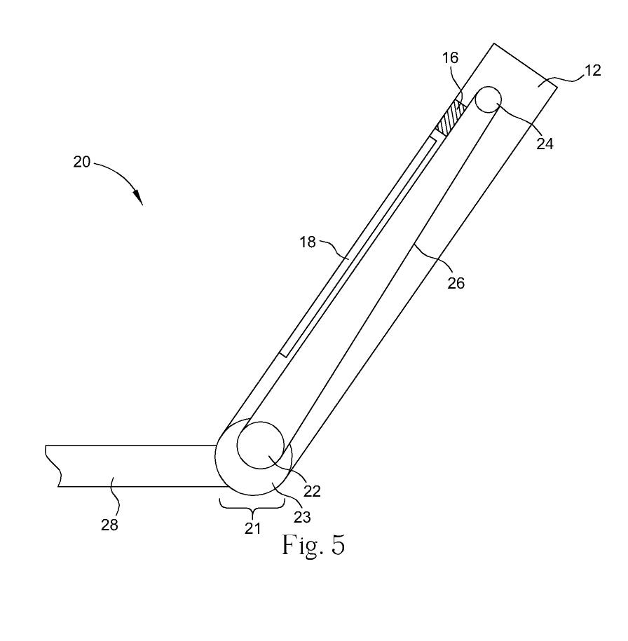

The present invention can be implemented in a foldable electronic device 20 shown in FIG. 5 for example. When the foldable electronic device 20 is unfolded, the user can use the method mentioned above to remove oil and such from the display panel 18. On the other hand, the cleaning function can be triggered while the foldable electronic device 20 is being unfolded or folded. The following will describe how to trigger the cleaning function while unfolding or folding a foldable electronic device.

Please refer to FIG. 5, which is a diagram of elements of the foldable electronic device 20. The foldable electronic device 20 is similar to the electronic device 10, and like reference numerals identify like components. The foldable electronic device 20 further comprises a body 28,a hinge 23 hinged at an end of the housing 12 and one end 21 of the body 28. In this embodiment, there are a first gear 22 and a connector 24 positioned at two sides of the track 14 respectively. A belt 26 is looped around the first gear 22 and the connector 24, and the sliding bar 16 is attached to the belt 26. When the hinge 23 makes the housing and the body rotate relatively, the first gear 22 rotates with drive of the hinge 23, the belt 26 looped around the first gear 22 is driven by the rotation of the first gear 22 so that the sliding bar 16 moves to clean the display panel 18.

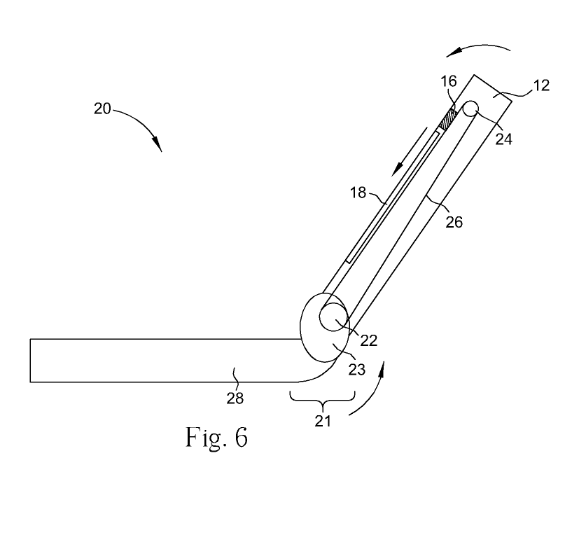

Please refer to FIG. 6, which is a diagram of the folding operation of the foldable electronic device 20. In FIG. 6, the foldable electronic device 20 is unfolded, and the location of the sliding bar 16 is at the end where the connector 24 is positioned. When the user pushes the housing 12 to fold the foldable electronic device 20, the housing 12 rotates relative to the body 28. As indicated by the directions of the arrows in FIG. 6, the first gear 22 rotates to drive the belt 26. Therefore, with the movement of the belt 26, the sliding bar 16 moves from the end nearest the connector 24 to the end nearest the first gear 22, such that the cleaning element 17 cleans the display panel 18.

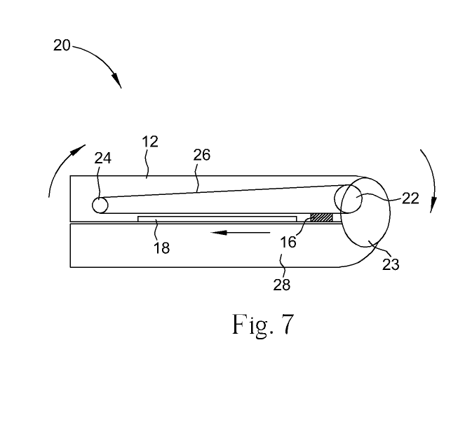

Please refer to FIG. 7, which is a diagram of operation of unfolding the foldable electronic device 20. When the foldable electronic device 20 is folded, the sliding bar 16 is at the end closest the first gear 22. The user can push the housing 12 to unfold the foldable electronic device 20, such that the housing 12 rotates relative to the body 28. As indicated by the directions of the arrows in FIG. 7, the first gear 22 rotates to drive the belt 26 and the connector 24 to rotate, and thereby the sliding bar 16 moves from the end nearer the first gear 22 to the end nearer the connector 24. This results in movement of the cleaning element 17 that removes oil, dust, and such from the display panel 18. The connector 24 of the present invention can be a cylinder, or a second gear to assist the movement of the belt 26.

As mentioned above, the display panel 18 is cleaned while folding or unfolding the foldable electronic device 20, using the assembly of the hinge 23, the first gear 22, and the belt 26 to drive the sliding bar 16. After the user utilizes the foldable electronic device 20, oil and such on the display panel 18 resulting from contact with the user's skin is immediately cleaned. In addition, the electronic device of the present invention can be a mobile phone, a digital camera, a notebook computer, or a personal digital assistant (PDA). Also, the present invention can be implemented in a liquid crystal display (LCD) panel to allow manual cleaning of the display panel or cleaning assisted by a step motor.

Compared to the prior art, the present invention provides an electronic device capable of cleaning the display panel. A cleaning element is set in the electronic device so that a user can use the cleaning element to clean the display panel anytime and anywhere. In another embodiment, a step motor can be used for driving the cleaning function.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a housing;
a display panel disposed on the housing;
a track formed on the housing; and
a sliding bar slidable on the track and having a cleaning element contacting the display panel for cleaning the display panel.

2. The electronic device of claim 1 further comprising a recess formed on an end of the track, the recess for accommodating the sliding bar.

3. The electronic device of claim 1 further comprising a step motor for driving the sliding bar to slide along the track.

4. The electronic device of claim 1 being a foldable phone, and further comprising:
a body;
a hinge hinged with the housing and the body;
a first gear connected to the hinge and positioned at one end of the track, wherein the hinge drives the first gear to rotate;
a connector positioned at the other end of the track; and
a belt looped around the first gear and the connector, the sliding bar fixed on the belt, the first gear rotating to drive the belt to move so that the sliding bar slides along the track for cleaning the display panel.

5. The electronic device of claim 4, wherein the connector comprises a second gear.

6. The electronic device of claim 1 comprising a mobile phone, a digital camera, a notebook computer, or a personal digital assistant (PDA).

7. The electronic device of claim 1, wherein the cleaning element is a wiping textile.
